(19) United States
(12) Patent Application Publication
(10) Pub. No.: US 2002/0198972 A1
(43) Pub. Date: Dec. 26, 2002

(54) Pre-boot multicast address management protocol for a computer network

(75) Inventors: David A. Babbitt, Round Rock, TX (US); Dwip N. Banerjee, Austin, TX (US); Rakesh Sharma, Round Rock, TX (US); Vasu Vallabhaneni, Austin, TX (US)

Correspondence Address: Edmond A. DeFrank, 19803 Ahwanee Lane, Northridge, CA, 91326, US

(73) Assignee: International Business Machines Corporation, Armonk, NY

(21) Appl. No.: 09/891,336

(22) Filed: Jun. 26, 2001

(51) Int. Cl. G06F 15/177

(52) U.S. Cl. 709/222

(57) ABSTRACT

A pre-boot multicast address management protocol for a computer network. This novel protocol includes an address conflict-clearing process that ensures that the same multicast address is not given to separate clients desiring different boot information. This address conflict-clearing technique alleviates any addressing conflicts and address duplication problems and enables multiple boot negotiation server processes to be present on the same network. The novel protocol of the present invention also provides a means for a boot negotiation server process and a multicast file server process to communicate in a bi-directional manner. Thus, the boot negotiation server process and the multicast file server process can communicate by sending messages and responses back and forth between each other. This communication feature allows the boot negotiation server process and the multicast file server process to reside on separate computers within the network.

### BACKGROUND OF THE INVENTION

1. Field of the Invention

The present invention relates in general to computer networks and more particularly to a multicast address management protocol for a computer network that resolves multicast addressing conflicts prior to booting of a client.

2. Related Art

Computer networks are widespread and vitally important to a multitude of diverse enterprises (such as business, university and government organizations). In general, a computer network is two or more computers (or associated devices) that are connected by communication facilities. A computer network may include a server, which is a computer that provides shared resources to users of the network, and a client system, which is a plurality of computers that access the shared network resources provided by the server using the communication facilities. One type of computer network is an intranet. An intranet is a limited network that usually is accessible only by authorized users. An authorized user accesses an intranet server using a client computer and may use the client to request and receive data located on the server.

Each client on the intranet may be capable of using different operating systems. The operating system that will be used by a client is determined prior to starting up (or booting) of the client. Once the operating system has been determined the client begins the process of booting by first obtaining the necessary operating system files from a file server process on the intranet. This process of obtaining the necessary files is called pre-boot. In general, during the pre-boot process a client determines a desired operating system that it will use, obtains a network address, obtains a multicast address, and listens at that multicast address for boot information containing the desired operating system files to be multicast. Once the client obtains the desired operating system files the client can begin booting. After booting, the client will be using the operating system corresponding to the operating system files that were multicast to the client at the multicast address. Multicasting is the transmission of information over the intranet to a select group of clients, such as those clients listening at a certain multicast address. Using multicasting, instead of a file server process transmitting boot information to one client at a time, the boot information may be transmitted to multiple clients simultaneously.

The pre-boot process begins when the client computer connected to the intranet is switched on. Firmware on the client begins negotiating with an addressing server process to obtain a network address for the client on the intranet. This network address informs other devices on the intranet where to find the client. One type of addressing server process is a Dynamic Host Configuration Protocol (DHCP) server process. When a client negotiates with a DHCP server process the client makes a request and receives an Internet Protocol (IP) address. This IP address gives the client a location on the intranet and tells other on the intranet where to find the client.

Once the client has obtained a network address (such as an IP address), the pre-boot process continues with the client making a request to a boot negotiation server process for a multicast address. The request contains the IP address of the client and the type of operating system that the client wants to use. The boot negotiation server process determines at which multicast address the boot information for the desired operating system is being multicast. This multicast address is then transmitted to the client. Once the multicast address corresponding to the boot information desired by the client has been obtained, the client then goes to the multicast address listens for the boot information. This boot information is multicast by a file server process to any clients that are listening at that particular multicast address.

A multicast address is the location on the intranet where the client can obtain boot information needed to boot the client with the desired operating system. In particular, a multicast address is a specialized form of an IP address. An IP address may be of any class from A to E. Each class has a different range of available addresses. However, only class D, having a range from 224.0.0.0 to 239.255.255.255, is specifically reserved for multicasting. Multiple clients can listen on a multicast address and obtain the data simultaneously when a file server process transmits the data.

One example of a multicasting pre-boot technique is the Pre-boot Execution Environment (PXE). PXE begins the pre-boot process by having a client send an addressing request to a Dynamic Host Configuration Protocol (DHCP) addressing server process. The DHCP server process then returns an Internet Protocol (IP) address to the PXE client. Once the PXE client has obtained an IP address, the client sends a request for the desired boot information to a Boot Information Negotiation Layer Directory (BINLD) server process. With this request the PXE client is asking the BINLD server process at which multicast address the client can find the desired boot information. This boot information may include, for example, the bootfile name and the location of the bootfile on a file server process. The BINLD server process then provides a multicast address to the client so that the client can receive the desired boot information.

Once the PXE client has obtained the multicast address, the PXE client goes to the multicast address and listens for a period of time. The client is waiting for a multicast trivial file transfer protocol (MTFTP) file server process to begin multicasting the desired boot information. If the multicasting does not begin within the period of time then the client initiates the multicasting by making a request to the MTFTP file server process to begin multicasting the desired boot information. If other clients happen to be listening at the multicast address when the MTFTP file server process begins multicasting, then these clients will also receive the boot information that is being multicast. On the other hand, if other clients desiring this boot information miss the multicast, then each of these clients can make a request to the MTFTP file server process to repeat the multicast.

There are problems, however, with the PXE and other existing multicasting pre-boot techniques. One problem is called address duplication. Address duplication can occur when there are multiple boot negotiation server processes on the intranet that provide different clients with the same multicast address. In this situation, a first boot negotiation server process assigns a first client a multicast address and then a second boot negotiation server process assigns a second client the same multicast address. A conflict occurs if the first client listens at the multicast address expecting to receive a first operating system and the second client listens at the same multicast address expecting to receive a second operating system. This conflict may cause the system to shutdown or crash. Thus, this address duplication problem prohibits more than a single boot negotiation server process from being located on the intranet.

Another problem with existing multicast pre-boot techniques is that there is no communication protocol that allows communication between a boot negotiation server process on one computer and a file server process on another computer. These two processes must communicate with each other, and if the two processes are located on separate machines then a communication protocol is needed. However, because existing techniques lack a communication protocol, the boot negotiation server process and a file server process must reside on the same computer. By residing on same computer the two processes can communicate by passing parameters and without using a communication protocol.

Both of these problems mean that existing multicast pre-boot techniques have little fault tolerance and lack robustness in the event of certain system and software failures. For example, if the only boot negotiation server process on the intranet fails then client will not be able to obtain necessary boot information and will be unable to boot. Moreover, if the single computer containing both the boot negotiation server process and the file server process stops working then clients also will be unable to boot. These two limitations of existing multicast pre-boot techniques can severely reduce their effectiveness and usefulness.

Therefore what is needed is a multicast pre-boot technique that prevents multicast address duplication and conflicts. Eliminating this address duplication problem would allow multiple boot negotiation server processes to be present on the intranet. What is further needed is a multicast pre-boot technique that provides a communication protocol between a boot negotiation server process and a file server process. This communication protocol would allow the two processes to reside on separate computers. Allowing multiple boot negotiation server processes on the intranet and enabling the boot negotiation server process and the file server process to reside on separate computers provides fault tolerance robustness.

### SUMMARY OF THE INVENTION

To overcome the limitations in the prior art as described above and other limitations that will become apparent upon reading and understanding the present specification, the present invention includes a pre-boot multicast address management protocol for a computer network. This novel protocol includes an address conflict-clearing process that eliminates address duplication and ensures that the same multicast address is not given to separate clients desiring different boot information. This address conflict-clearing technique enables multiple boot negotiation server processes to be present on the same intranet. The present invention also includes a communications protocol that allows a boot negotiation server process and a multicast file server process to communicate remotely. This communication protocol allows the boot negotiation server process and the multicast file server process to reside on separate computers within the intranet.

Generally, the present invention includes a method for transmitting boot information to a client on an intranet computer network. The method includes using the client to request desired boot information. Next, a multicast address is selected. This multicast address is where the desired boot information will be multicast. It is determined if the multicast address selected is being used to multicast different information than the desired boot information. If not, then the multicast address is transmitted to the client.

The multicast address is selected and transmitted to the client by a boot negotiation server process. The present invention includes prevents address duplication and conflicts thereby allowing multiple boot negotiation server processes on the intranet. Address duplication and addressing conflicts are prevented by using a first boot negotiation server process to determine whether other boot negotiation server processes are using a selected multicast address. This is achieved by using the first boot negotiation server process to send a conflict query to the other boot negotiation server processes. The first boot negotiation server process (or querying boot negotiation server process) then listens for conflict queries from the other boot negotiation server processes. If none are received after a predefined period of time, then the querying boot negotiation server process transmits the selected multicast address to the requesting client. If a response to the conflict query is received, this means there is a conflict. The querying boot negotiation server process keeps selecting a different multicast address and querying the other boot negotiation server processes until a multicast address is found that is not being used.

The present invention also includes a communication protocol that is used to facilitate communication between the boot negotiation server process and the file server process. This communication protocol includes using the boot negotiation server process to send a notification to the file server process to prepare for a client request, having the file server process prepare to receive a client request, and notifying the boot negotiation server process that the file server process is ready for a client request.

Other aspects and advantages of the present invention as well as a more complete understanding thereof will become apparent from the following detailed description, taken in conjunction with the accompanying drawings, illustrating by way of example the principles of the invention. Moreover, it is intended that the scope of the invention be limited by the claims and not by the preceding summary or the following detailed description.

### BRIEF DESCRIPTION OF THE DRAWINGS

The present invention can be further understood by reference to the following description and attached drawings that illustrate the preferred embodiments. Other features and advantages will be apparent from the following detailed description of the invention, taken in conjunction with the accompanying drawings, which illustrate, by way of example, the principles of the present invention.

Referring now to the drawings in which like reference numbers represent corresponding parts throughout:

FIG. 1 illustrates a conventional hardware configuration for use with the present invention.

FIG. 2 is a block diagram of an individual computer system of FIG. 1 incorporating the present invention and is shown for illustrative purposes only.

FIG. 3 is a general block/flow diagram illustrating the components of the present invention.

FIG. 4 is a flow diagram illustrating the general operation of the pre-boot address management protocol of the present invention.

FIG. 5A is a detailed flow diagram illustrating a working example of the address conflict-clearing technique of the present invention upon receipt of a client request.

FIG. 5B is a detailed flow diagram illustrating a working example of the address conflict-clearing technique of the present invention upon receipt of a conflict query.

### DETAILED DESCRIPTION OF THE INVENTION

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

I. Introduction

Pre-boot techniques are important in computer networks because they allow a client machine to be booted in a consistent and reliable manner. Current pre-boot techniques use a boot negotiation server process and a file server process. The boot negotiation server platform contains both a boot negotiation server process and a file server process. The address server process provides to a requesting client the address of the boot negotiation server platform. The boot negotiation server process tells the client how and where to find a bootfile that the client can boot from and the file server process provides the client with the bootfile.

There are several problems with current pre-boot techniques. First, existing techniques are neither capable of supporting multiple boot negotiation server processes residing on the same network. Moreover, these techniques are not capable of supporting the situation where the boot negotiation server process and the file server process reside on different machines. This is because current pre-boot techniques are unable to provide a mechanism to avoid addressing conflicts where different boot negotiation server processes give out the same boot information. Thus, if a network using current pre-boot techniques was to use multiple boot negotiation server processes and an address conflict were to arise, this may cause the client to be unable to boot. Moreover, current pre-boot services do not support the situation where the boot negotiation server process and the file server process do not reside on the same machine because there is no way specified for them to communicate with each other about such matters as bootfile names, multicast addresses and port numbers.

The present invention solves these problems by providing a pre-boot technique having a novel pre-boot address management protocol that supports the use of multiple boot negotiation server processes residing on the same network. Moreover, the present invention allows a boot negotiation server process to reside on a different machine than a file server process. This support greatly increases the robustness of the computer network and provide invaluable fault tolerance. In other words, the present invention provides a failsafe booting process by allowing primary and secondary server machines to be used such that the secondary server machines take over in case the primary server machines fail. The present invention also allows a scalable setup and ensures that identical multicast addresses and port numbers will not be used to multicast two different bootfiles. The present invention achieves this because the pre-boot address management protocol includes an address conflict-clearing technique that whereby a querying boot negotiation server process sends a conflict query to other boot negotiation server processes on the network to determine whether they are using any of the same boot information. If a response is received stating that the particular boot information is being used, the querying boot negotiation server process selects different boot information and broadcasts another query. If no responses are received, then the querying boot negotiation server process configures a file server process to multicast bootfiles to the multicast address. In this manner, any conflict between boot information is resolved prior to booting and a reliable boot is ensured.

II. Exemplary Operating Environment

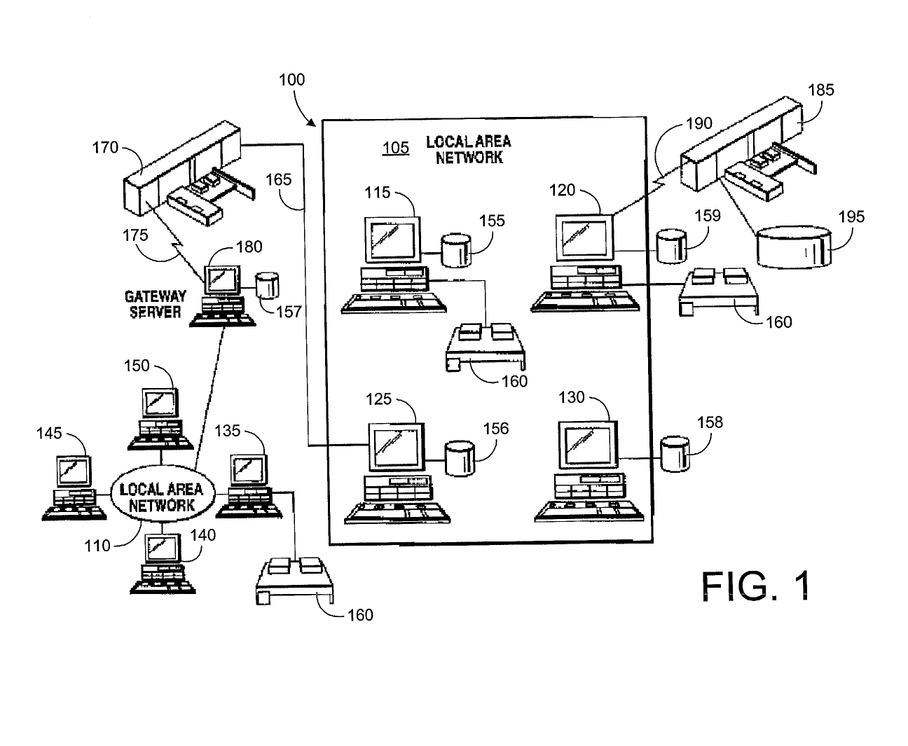

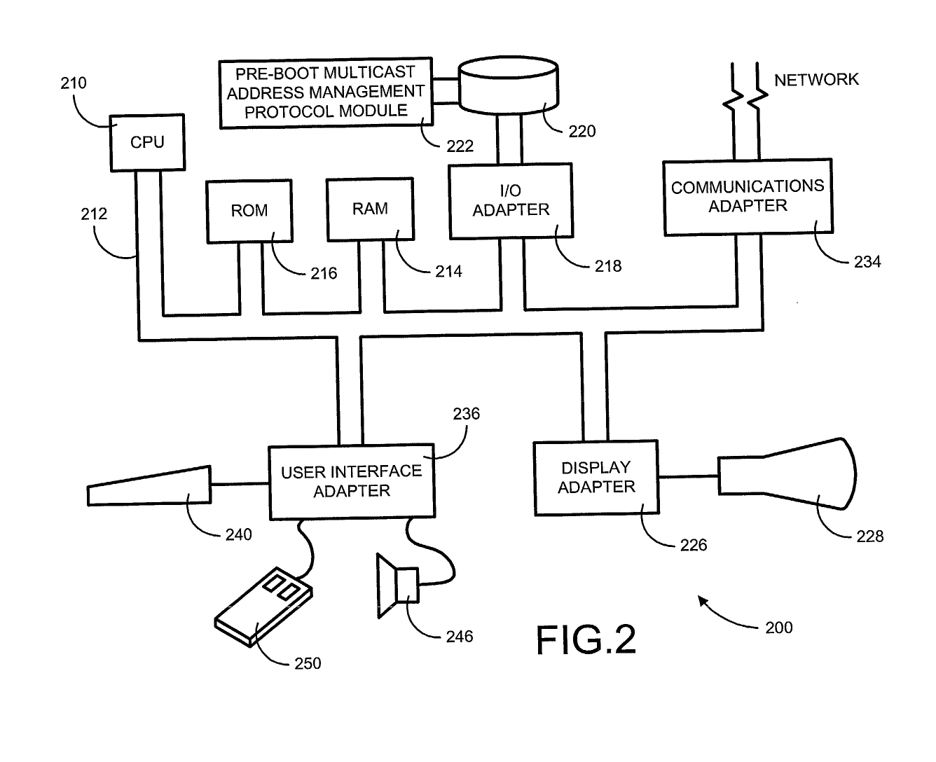

The following discussion is designed to provide a brief, general description of a suitable environment in which the present invention may be implemented. It should be noted that FIGS. 1 and 2 depict only one of several ways in which the present invention may be implemented.

FIG. 1 illustrates a conventional hardware configuration for use with the present invention. In particular, an enterprise computer system 100 may include one or more networks, such as local area networks (LANs) 105 and 110. Each of the LANs 105, 110 includes a plurality of individual computers 115, 120, 125, 130, 135, 140, 145 and 150.

The computers within the LANs 105, 110 may be any suitable computer such as, for example, a personal computer made by International Business Machines (IBM) Corporation, located in Armonk, N.Y. Typically, each of the plurality of individual computers is coupled to storage devices 155, 156, 157, 158 and 159 (such as a disk drive or hard disk) that may be used to store data (such as modules of the present invention) and computer-executable instructions in accordance with the present invention. Each of the plurality of individual computers 115, 120, 125, 130, 135,140, 145, 150 also may be coupled to an output device 160 (such as a printer) for producing tangible output. The LANs 105, 110 may be coupled via a first communication link 165 to a communication controller 170, and from the communication controller 170 through a second communication link 175 to a gateway server 180. The gateway server 180 is preferably a personal computer that serves to link the LAN 105 to the LAN 110.

The computer system 100 may also include a plurality of mainframe computers, such as a mainframe computer 185, which may be in communication with one or more of the LANs 105, 110 by means of a third communication link 190. The mainframe computer 185 is typically coupled to a storage device 195 that is capable of serving as a remote storage for one or more of the LANs 105, 110. Similar to the LANs 105,110 discussed above, the storage device may be used to store data and computer-executable instructions in accordance with the present invention. Those skilled in the art will appreciate that the mainframe computer 185, the LAN 105 and the LAN 110 may be physically located a great distance from each other. By way of example, a user may use a client system of the mainframe computer 185 to access information located on a server of the LAN 105.

FIG. 2 is a block diagram of an individual computer system of FIG. 1 incorporating the present invention and is shown for illustrative purposes only. A computer 200 includes any suitable central processing unit (CPU) 210, such as a standard microprocessor, and any number of other objects interconnected by a system bus 212. For purposes of illustration, the computer 200 includes memory such as random-access memory (RAM) 214, read-only memory (ROM) 216, and storage devices (such as hard disk or disk drives 220) connected to the system bus 212 by an input/output (I/O) adapter 218. The computer 200 may be a client machine that is capable of connecting and interacting with a server using network packets.

The storage device 220 contains a pre-boot multicast address management protocol module 222 containing the pre-boot address management protocol of the present invention. This module 222 preferably includes computer-executable instructions for carrying out the protocol of the present invention as described below. As explained below, the pre-boot address management protocol module 222 preferably is resident in each machine containing a boot negotiation server process.

The computer 200 further includes a display adapter 226 for connecting the system bus 212 to a suitable display device 228. In addition, a user interface adapter 236 is capable of connecting the system bus 212 to other user interface devices, such as a keyboard 240, a speaker 246, a mouse 250 and a touchpad (not shown). In a preferred embodiment, a graphical user interface (GUI) and an operating system (OS) reside within a computer-readable media and contain device drivers that allow one or more users to manipulate object icons and text on the display device 228. Any suitable computer-readable media may retain the GUI and OS, such as, for example, the RAM 214, ROM 216, hard disk or disk drives 220 (such as magnetic diskette, magnetic tape, CD-ROM, optical disk or other suitable storage media).

III. General Component Overview

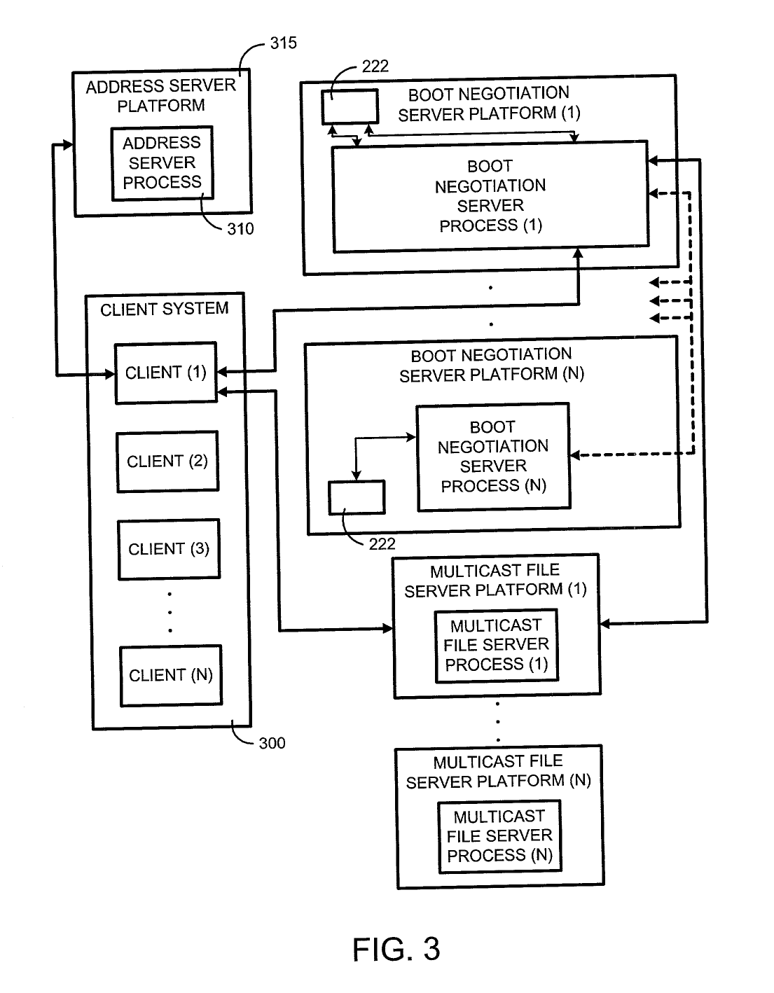

The pre-boot multicast address management protocol module 222 of the present invention includes an address management protocol that manages the delivery of boot information to a client so that the client can boot. FIG. 3 is a general block/flow diagram illustrating components of the present invention. In general, FIG. 3 illustrates a client system 300 having a client that may want to boot and an addressing server process 310 for delivering a network address to the client. Moreover, FIG. 3, illustrates a plurality of boot negotiation processes on a network, which provide boot information to the client, and a plurality of file server processes that provide a bootfile to the client. Located on each of the boot negotiation server platforms (1) to (N) is the pre-boot multicast address management protocol module 222 containing the protocol of the present invention. The client system 300 includes a plurality of client machines including client (1), client (2), client (3) up to client (N). The address server process 310 resides on an address server platform 315 (such as the computer platform described above). The address server process 310 distributes network address information to a client upon request. By way of example, the address server process 310 may be a DCHP server process. FIG. 3 also illustrates a plurality of boot negotiation server platforms including boot negotiation server platform (1) to boot negotiation server platform (N). Each of these boot negotiation server platforms may have either a single boot negotiation server process or a plurality of boot negotiation processes located on the server platform. A plurality of multicast file server platform (numbered (1) to (N)) include corresponding multicast file server process (1) to (N) are used to multicast a bootfile to a requesting client.

IV. General Operation and Working Example

In general, the pre-boot multicast address management protocol of the present invention enables multiple boot negotiation server processes to reside on the same network and also allows a multicast file server process to reside on a different machine than a boot negotiation server process. The protocol of the present invention achieves this by establishing a communication protocol between the boot negotiation server process and the multicast file server process and by using a pre-boot conflict-clearing process that ensures identical boot information (such as multicast addresses and port numbers) will not be used to multicast two different bootfiles. As described below, conflicts are avoided by having a querying boot negotiation server process broadcast a query to other boot negotiation server processes inquiring about the use of the boot information. In effect, the querying boot negotiation server process “clears” the boot information with the other boot negotiation server processes on the network prior to sending the boot information to the client. This alleviates any conflicts and ensures that identical boot parameters are not used to multicast two different bootfiles. The protocol of the present invention then has the boot negotiation server process notify the multicast file server process that contains the proper bootfile that the client will be requesting for the bootfile. This allows the multicast file server process to prepare for the client request. When it is ready to receive the client's request, the multicast file server process sends an acknowledgement to the boot negotiation server process.

Referring to FIG. 3, the pre-boot process will now be described. First, client (1) sends a request for an address to the address server process 310. The address server process 310 responds and allocates a network address for the client to communicate with a boot negotiation process. Client (1) then uses the network address to contact boot negotiation server process (1). Based on the request of client (1), the boot negotiation server process (1) selects boot information and then clears the boot information with the remainder of the boot negotiation server processes. As shown in FIG. 3 by the dashed line, this is accomplished by broadcasting or multicasting a query to each of the boot negotiation server processes and asking them if they are using the boot information. Once the boot information has been cleared the boot negotiation server process (1) then notifies the multicast file server process (1) that client (1) will be requesting a bootfile. Multicast file server process (1) configures itself to accept a request from client (1) and then sends an acknowledgement that the multicast file server process (1) is ready. The boot negotiation server process (1) then gives the boot information to client (1). If required, the client sends the request to the multicast file server process.

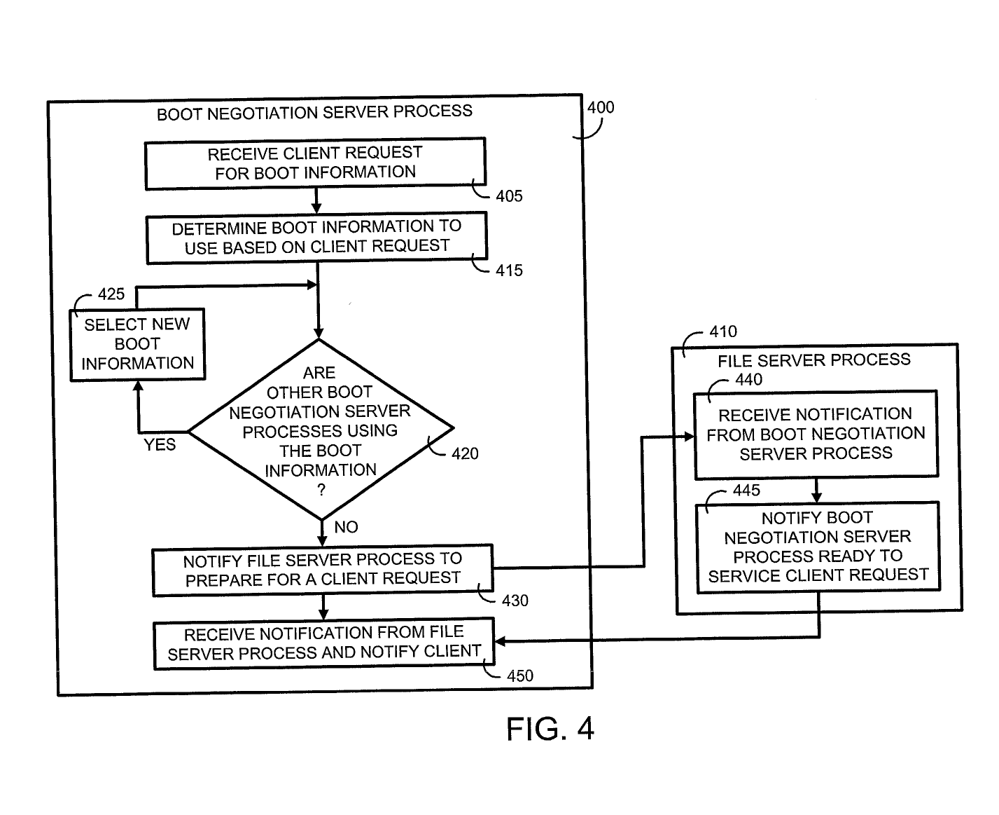

FIG. 4 is a flow diagram illustrating the general operation of the pre-boot conflict-clearing process and the communication process of the present invention. In particular, a boot negotiation server process 400 receives a client request for boot information (box 405), such as how and where to find the proper bootfile. In this example, the bootfile is contained within a file server process 410. The boot negotiation server process 400 determines boot information based on the client request (box 415). A determination is then made as to whether other boot negotiation server processes on the network are using the boot information (box 420). As described above, preferably this is accomplished by sending a query to each of the other boot negotiation server processes asking whether they are using the boot information. If so, then the boot negotiation server process 400 selects new boot information (box 425). Otherwise, the boot negotiation server process 400 notifies the file server process 410 to prepare for the client to request a certain bootfile (box 430).

The file server process 410 receives the notification from the boot negotiation server process 400 and prepares for the client request (box 440). When the file server process 410 is prepared, it sends an acknowledgement to the boot negotiation server process 400 that the file server process 410 is ready to receive the client's request. The boot negotiation server process 400 receives the notification from the file server process 410 and then notifies the client and sends the boot information to the client (box 450).

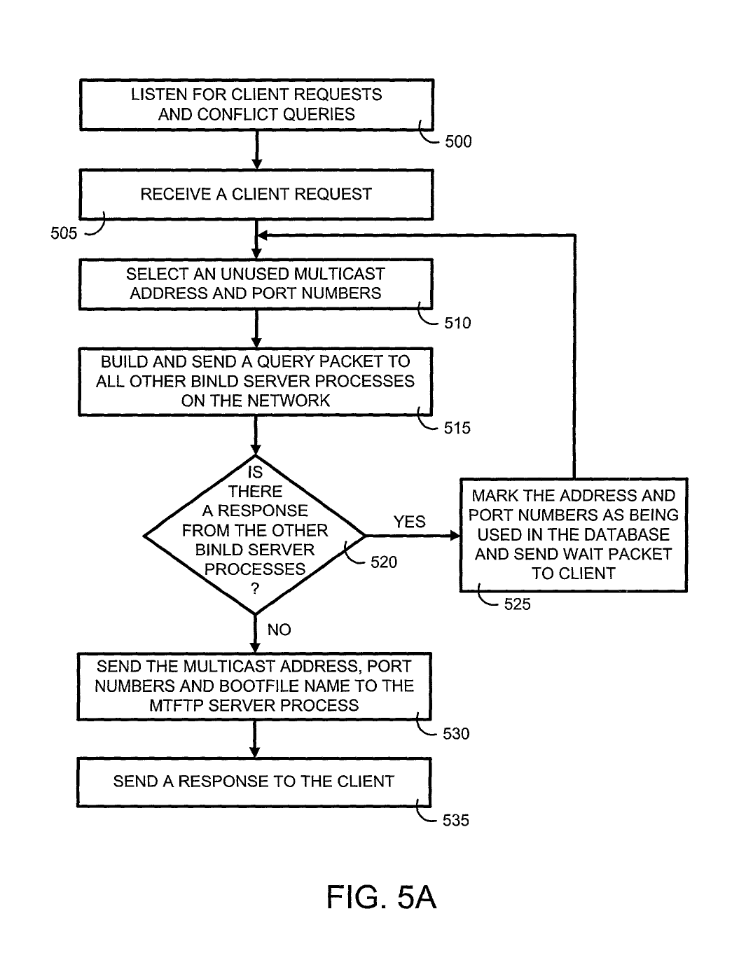

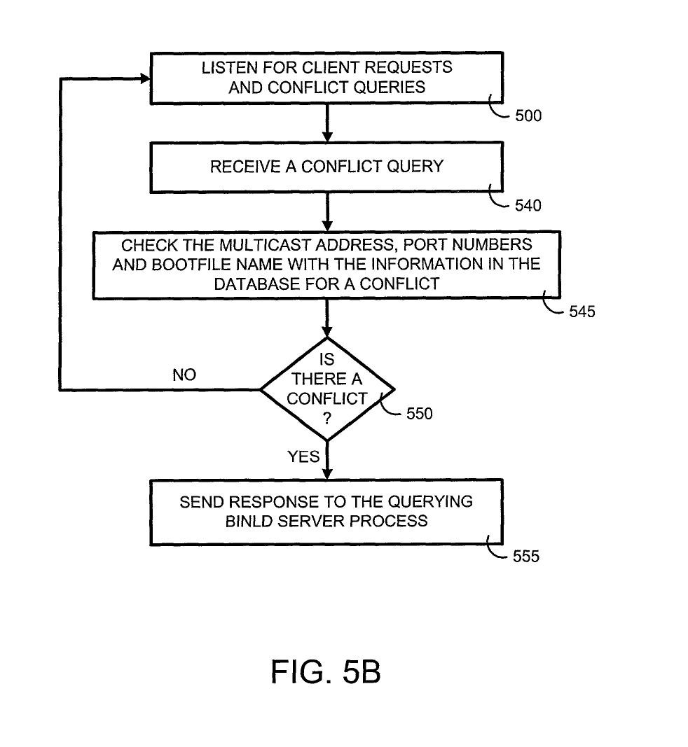

The following discussion is a working example illustrating an exemplary embodiment of the address conflict-clearing process of the present invention. In this working example, the pre-boot process is PXE services, the boot negotiation server process is a BINLD server process and the multicast file server process is a MTFTP server process. FIGS. 5A and 5B detail how a boot negotiation server process (such as a BINLD server process) handles a request from a client and a conflict query from another BINLD server process using the address conflict-clearing process of the present invention.

FIG. 5A is a detailed flow diagram illustrating a working example of the address conflict-clearing process of the present invention upon receipt of a client request. This figure illustrates how a boot negotiation server process sends a conflict query to other boot negotiation server processes on the network. In this working example, the BINLD server process using the address conflict-clearing process of the present invention listens for client requests and for conflict queries from other BINLD server processes (box 500). A client request is received (box 505), and the BINLD server process selects boot information, which in this working example is a multicast address, a file server port number and client port number (box 510). The BINLD server process then checks for conflicts by building and sending a conflict query to all other BINLD server processes on the network that are listening on a specific port (box 515).

It is then determined whether there is a response from any of the other BINLD server processes on the network (box 520). Preferably, there is a period of time in which a response must be received. If a response is received from another BINLD server process, the multicast address and port numbers are marked in a database as being used and a wait packet is sent to the client (box 525). Different unused multicast address and port numbers are selected (box 510). If a response is not received, then the multicast address, port numbers and bootfile name are sent to the MTFTP server process (box 530) and a response is sent to the client (box 535).

FIG. 5B is a detailed flow diagram illustrating a working example of the address conflict-clearing process of the present invention upon receipt of a conflict query. This figure illustrates how a boot negotiation server process receives and response to a conflict query sent from another boot negotiation server process on the network. As in FIG. 5A, a BINLD server process using the address conflict-clearing process of the present invention listens for client requests and for conflict queries from other BINLD server processes (box 500). In this situation, however, a packet containing a conflict query is received (box 540). The receiving BINLD server process then checks the multicast address, port numbers and bootfile name with information in the database (box 545). A determination is then made as to whether a conflict exist (box 550). If there is no conflict, then the receiving BINLD server process continues to listen for client requests and conflict queries (box 500). If there is a conflict, the receiving BINLD server process sends a response to the querying BINLD server process to notify the querying BINLD server process of the conflict (box 555).

More specifically, in this working example the conflict query packet includes an Opcode (where “0” is the query and “1” is a response) of 1 byte, a length of the conflict query packet (2 bytes), the MTFTP server process IP address (4 bytes) and the type of BINLD server process (2 bytes). In addition, the conflict query packet further contains a layer (2 bytes), a multicast address allocated by the BINLD server process for the filename (4 bytes), a port number (2 bytes), a bootfile name length (1 byte) and the bootfile name (which can be varied in size). Any response sent by a receiver of the conflict query packet is an echo of the conflict query packet with the Opcode set to “1”.

When a BINLD server process is querying other BINLD server processes on the network the querying BINLD server process sends a packet to the client asking the client to wait for a period of time. If an addressing conflict is found, then the querying BINLD server process sends another packet to the client asking the client to wait for an additional period of time. This is done to alleviate network traffic, so that the client will not keep querying the BINLD server process as to the status of the client.

In response to the querying BINLD server process's conflict query packet, a BINLD server process receiving the query packet may not response to the query packet may not respond in several situations. First, the receiving BINLD server process will not respond to the query packet if the querying BINLD server process is using the same MTFTP server to multicast a portion of the same boot information as the receiving BINLD server process. Second, the receiving BINLD server process will not respond if the querying BINLD server process is using the same MTFPT server process to multicast a different file on a different multicast address and the receiving BINLD server is not using that multicast address to multicast another file. Finally, the receiving BINLD server process will not respond to the query packet if the querying BINLD server process is using a different MTFTP server process and the multicast address used to multicast the file is not used to multicast a file by the receiving BINLD server process.

After the address conflict-clearing process has ensured that no other BINLD server processes are using the same multicast address and port numbers, the BINLD server process sends the packet to configure the MTFTP server process. This is performed by sending a unicast packet to the MTFTP server process that contains a bootfile name, multicast address and port numbers. The MTFTP server process sends an acknowledgement after it is successfully configured to multicast the bootfile, even if the MTFTP server process is already configured by another BINLD server process with the same address and bootfile name. The MTFTP server process sends a negative acknowledgement only if the address is in use or the bootfile does not exist. Each MTFTP server process maintains a list of BINLD server processes from which the MTFTP server process has received a request for multicasting a boot file over a specific multicast address. A BINLD server process address will be removed from the list only when a request is received from a BINLD server process to delete. The multicast address is released by the MTFTP server process only when the only when the list of BINLD server processes becomes empty. Once released, the multicast address becomes available.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description of the invention, but rather by the claims appended hereto.

What is claimed is:

1. A method for providing boot information to a client on a computer network, comprising:
selecting a multicast address at which the boot information will be multicast;
determining whether the selected multicast address is being used to multicast information different from the boot information; and
transmitting the selected multicast address to the client if the selected multicast address is not being used.

2. The method as set forth in claim 1, wherein determining whether the selected multicast address is being used to multicast information different from the boot information includes transmitting a conflict query.

3. The method as set forth in claim 1, wherein a plurality of boot server processes are present on the computer network.

4. The method as set forth in claim 3, further comprising using a file server process to multicast the boot information to the client at the selected multicast address, wherein the file server process and at least one of the plurality of boot server processes are located on different machines.

5. The method as set forth in claim 4, further comprising:
using one of the plurality of boot server processes to notify the file server process that the client will be making a request to the file server process; and
using the file server process to transmit an acknowledgement that the file server process is ready for the client to make the request.

6. The method as set forth in claim 5, further comprising configuring the file server process for the request from the client system after receiving notification from the one of the plurality of boot server processes and before sending the acknowledgement.

7. The method as set forth in claim 3, wherein determining whether the selected multicast address is being used to multicast information different from the boot information includes transmitting a conflict query from a querying boot server process to a remainder of the plurality of boot server processes.

8. The method as set forth in claim 7, further comprising selecting a different multicast address if the selected multicast address is being used to multicast information different from the boot information.

9. The method as set forth in claim 7, wherein an address conflict is found if one of the remainder of the plurality of boot server processes sends an acknowledgement to the conflict query.

10. The method as set forth in claim 8, further comprising marking the selected multicast address as being used and storing the marked selected multicast address in a database.

11. The method as set forth in claim 1, further comprising using the client to listen at the selected multicast address for the boot information to be multicast.

12. The method as set forth in claim 11, wherein the client listens at the selected multicast address for a period of time.

13. The method as set forth in claim 12, further comprising:
receiving no response during the period of time; and
using the client to send a request to a file server process to transmit the boot information at the selected multicast address.

14. The method as set forth in claim 11, further comprising using the client to receive the boot information from a file server process that is multicasting the boot information at the selected multicast address.

15. A method for resolving address conflicts on a computer network prior to booting a client, comprising:
using a first boot server process on the network to determine whether other boot negotiation server processes on the network are using a first multicast address; and
sending the first multicast address to the client if the first multicast address is not being used by the other boot negotiation server processes;
selecting a second multicast address if the first multicast address is being used by the other boot negotiation server processes.

16. The method as set forth in claim 15, further comprising using the client to listen at the first multicast address to receive boot information.

17. The method as set forth in claim 15, wherein using a first boot server process on the network to determine whether other boot negotiation server processes on the network are using a first multicast address further comprises causing the first boot server process to transmit a conflict query to the other boot negotiation server processes over the computer network.

18. A pre-boot address management method for configuring a file server process on a computer network to send boot information to a client, comprising:
causing a first boot server process on the computer network to select a first multicast address;
using the first boot server process to send a query packet to other boot negotiation server processes on the computer network to determine whether the first multicast address is being used to provide information different from the boot information; and
using the first boot server process to notify the file server process that the client will be requesting boot information at the first multicast address if the first multicast address is not being used to provide information different from the boot information;
wherein the first boot server negotiation process and the file server process are located on separate machines.

19. The pre-boot address management method as set forth in claim 18, wherein a response to the query packet is received by the first boot server process if the first multicast address is being used to provide information different from the boot information.

20. The pre-boot address management method as set forth in claim 18, wherein the first server process selects a different multicast address if the first multicast address is being used to provide information different from the boot information.
